(19) United States
(12) Patent Application Publication
(10) Pub. No.: US 2018/0356588 A1
(43) Pub. Date: Dec. 13, 2018

(54) LIGHT SCATTERING FIBER AND DEVICES INCORPORATING SAME

(71) Applicant: TECLens, LLC, St. James, NY (US)

(72) Inventors: Patrick David Lopath, Stamford, CT (US); Edward Paul Harhen, Duxbury, MA (US)

(21) Appl. No.: 16/007,232

(22) Filed: Jun. 13, 2018

Related U.S. Application Data
(60) Provisional application No. 62/518,971, filed on Jun. 13, 2017.

(51) Int. Cl. G02B 6/02

(52) U.S. Cl. CPC G02B 6/02309; G02B 6/02033

(57) ABSTRACT

An optical fiber includes a core (30) and a cladding (32) surrounding the core. One or more indentations (42) extend into the fiber from outside of the core. The indentations desirably extend into the core and desirably define surfaces (44) transverse to the axis (36) of the fiber and extending into the core. A solid filler material (52) desirably is disposed within the indentations. The indentations and filler facilitate extraction of light from the core. The fiber desirably is a polymeric multimode fiber.

### CROSS-REFERENCE TO RELATED APPLICATIONS

The present application claims the benefit of U.S. Provisional Patent Application No. 62/518,971, filed Jun. 13, 2017, the disclosure of which is incorporated herein by reference herein.

### BACKGROUND OF THE INVENTION

The present invention relates to optical fibers and devices incorporating the same.

An optical fiber is an elongated structure which typically includes a transparent solid core extending along the axis of elongation of the fiber and a transparent cladding layer surrounding and contacting the core. The cladding has an index of refraction lower than the index of refraction of the core. The “index of refraction” of a material is a measure of the speed of light in the material relative to the speed of light in a vacuum; the higher the index, the lower the speed of light in the material. Light can travel along the fiber in directions parallel to the axis of the fiber and within a certain range from perfectly parallel to the axis. Light which is not perfectly parallel to the axis will eventually encounter the interface between the core and the cladding. As further explained below, light passing along the fiber at a relatively small angle to the axis will encounter the interface between the core and cladding and will be directed back into the core by a phenomenon referred to as “total internal reflection.” Thus, light can be transmitted along the length of the fiber with minimal loss of light into the cladding or the surroundings. For example, common optical fibers can be used to transmit pulses of light over distances of kilometers or more in optical communication systems.

In other applications, optical fibers are used to provide illumination, most typically by directing light from a source at one end of the fiber so that the light exits from the opposite end of the fiber and passes out of the fiber at the opposite end.

Various proposals have been advanced for making optical fibers which will scatter some of the light passing along the fiber in radial directions, transverse to the axis of the fiber, so as to provide illumination along the length of the fiber for utilitarian or decorative purposes. Such a fiber is commonly referred to as “radially scattering” or “radially dispersive” optical fiber. The commercially available radially scattering optical fibers typically are former with a glass core and glass cladding. The brittle nature of such fibers limits their applicability. Moreover, because the processes commonly used to make radially scattering optical fibers are applied during formation of the fiber itself, such fibers are only available as a continuous length of radially scattering fiber. To provide illumination over a short length of radially dispersive fiber disposed remote from the light source, a separate length of transmission optical fiber typically is required. The two fibers must be coupled to one another, which adds to the cost, complexity, and bulk of the device.

### BRIEF SUMMARY OF THE INVENTION

One aspect of the invention provides an optical fiber having an elongated transparent core having an axis of elongation, a cladding surrounding the core, the cladding having an index of refraction lower than an index of refraction of the core, and one or more indentations extending from outside of the cladding into the core so that the indentations define one or more surfaces extending towards and away from the axis of elongation and extending into the core.

A further aspect of the invention provides an optical fiber having an elongated transparent core, a cladding surrounding the core, the cladding having an index of refraction lower than an index of refraction of the core, one or more indentations extending from outside of the cladding at least to the core, and an optically transmissive solid filler disposed in the indentations.

As further explained below, the indentations facilitate extraction of light from the core. The solid filler structurally reinforces the fiber and also facilitates extraction of light from the core. Thus, particularly preferred fibers incorporate both aspects of the invention discussed above.

Most desirably, the core and cladding of the fiber are formed from polymeric materials. The fiber may have an emission region incorporating the indentations, and may also incorporate a transmission region devoid of the indentations.

Further aspects of the invention provide optical devices incorporating fibers as discussed above. The emission region may be curved as, for example, to form a loop. The optical device may also incorporate a solid coupling material surrounding the emission region of the fiber.

### BRIEF DESCRIPTION OF THE DRAWINGS

FIG. 1 is a diagrammatic elevational view of a fiber according to one embodiment of the invention.

FIG. 2 is a sectional view taken along line 2-2 in FIG. 1.

FIG. 3 is a fragmentary, diagrammatic sectional view of the region indicated in FIG. 1, taken along line 3-3 in FIG. 2.

FIG. 4 is a view similar to FIG. 3, but depicting the region indicated by 4 in FIG. 1.

FIG. 5 is a schematic view depicting light rays in operation of the fiber of FIGS. 1-4.

FIGS. 6-8 are views similar to FIG. 3, but depicting fibers according to further embodiments of the invention.

FIG. 9 is a diagrammatic perspective view depicting an optical device according to a further embodiment of the invention.

### DETAILED DESCRIPTION

An optical fiber in accordance with one aspect of the present invention includes a core 30 having a circular cross-section as best seen in FIG. 2 and a central axis 36 extending in the direction of elongation of the core. In this embodiment, core 30 is formed from a transparent polymeric material and has a diameter greater than about 50 micrometers. Most typically, the core has a diameter less than about 1 mm, and typically less than about 0.5 mm (500 micrometers). Where the core is formed from acrylic polymer, core 30 typically has an index of refraction between about 1.47 to 1.51. The fiber further includes a cladding 32 surrounding core 30 and in contact with the outer surface of the core at a core-to-cladding interface 31. The cladding has a cylindrical outer surface 33. Cladding 32 is formed from a transparent polymeric material, in this instance a transparent polymer having an index of refraction lower than the index of refraction of the core. For example, the index of refraction of the cladding 32 may be on the order of 1.40. Cladding 32 is formed as a relatively thin layer covering the outer surface of core 30. For example, the outer diameter of cladding 32 desirably is no more than about 120% of the diameter of core 30, more preferably about 110% of the core diameter or less of the diameter of the core, and most preferably about 105% of the core diameter or less. However, cladding 32 desirably has a thickness of a few microns or more. The foregoing elements of the fiber may be the same as those used in a conventional plastic optical fiber of the type referred to as a “multimode” optical fiber. The fiber includes a transmission section 38 adjacent to one end 39, referred to herein as the “upstream” end . Within transmission section 38, the core and cladding are continuous and uninterrupted.

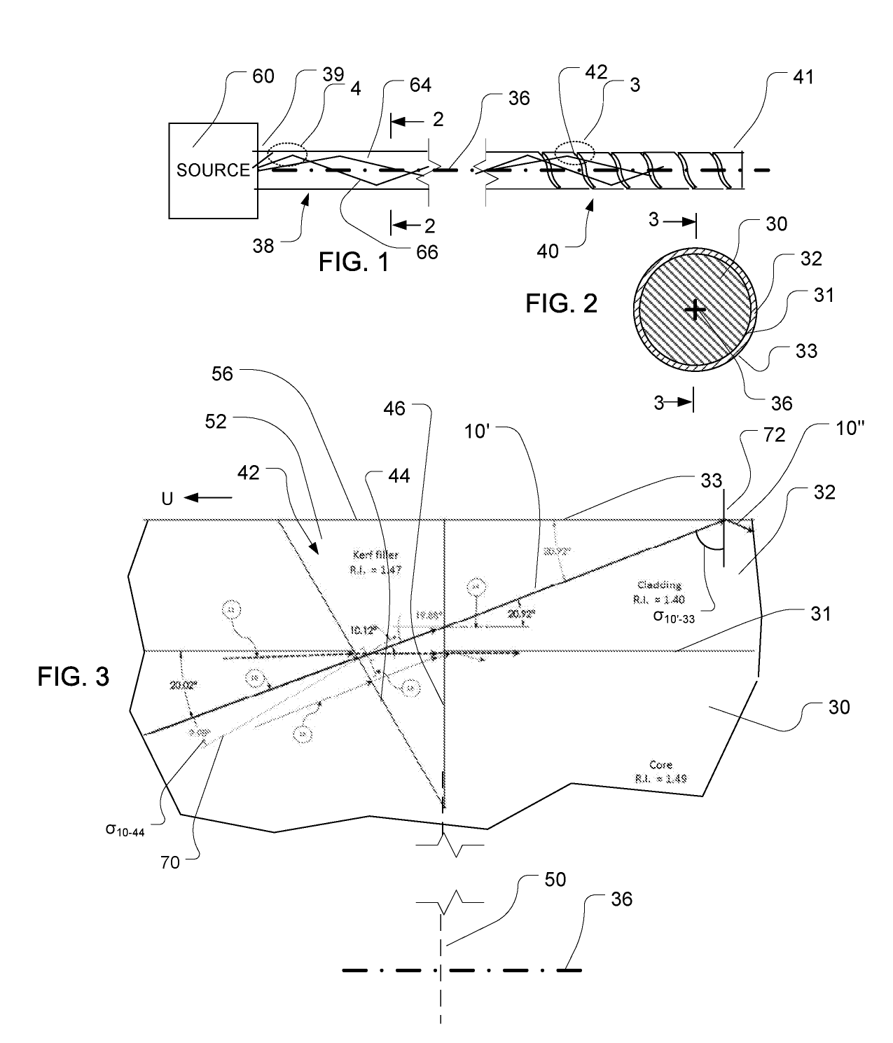

The fiber of FIGS. 1 and 2 also includes an emission region 40, which includes the same core and cladding as the transmission region. In this embodiment, the emission region 40 is disposed adjacent the downstream end 41 of the fiber. Within emission region 40, the fiber has an indentation 42 in the form of a helix extending around the axis 36 of the fiber, and extending along the length of the fiber. As best seen in detail in FIG. 3, indentation 42 has a generally triangular cross-sectional shape and extends into the fiber from the outer surface of cladding 32, through the cladding, and into the core 36. Indentation 42 is also referred to herein as a “kerf.” As seen in FIG. 3, the indentation or kerf 42 has a generally triangular shape. FIG. 3 is a sectional view showing one point on the helical indentation at diametric plane 3-3 (FIG. 2) extending through the axis 36. The shape of the indentation is described herein as the shape seen in sectional view on a diametric such as the plane shown in FIG. 3. Downstream surface extends along a radial line 50 perpendicular to the axis 36 of the fiber. Upstream surface 44 is oblique to the radial line 50 and oblique to the axis 36. The upstream surface slopes in the upstream direction indicated by arrow U in FIG. 3, and thus slopes toward the upstream end 39 (FIG. 1) of the fiber. The oblique upstream surface 44 extends into the core 36, beyond the outer radius of the core 36 and beyond the cylinder forming the interface 31 between the core and the cladding remote from the indentation.

Kerf or indentation 42 is filled with a solid filler material 52. As depicted in FIG. 3, the solid filler material 52 exactly fills the kerf so that the filler material forms an outwardly facing surface 56 continuous with the outer surface 33 of cladding 32. However, in practice, the outer surface of the filler material may be slightly recessed from surface 33, or may protrude from the surface. The solid filler material is a light-transmitting material and in this embodiment is a transparent material, i.e., a material which can transmit light without substantial scattering of the light transmitted through it. The solid filler material may have an index of refraction comparable to the indices of refraction of the core and cladding and may, for example, have an index of refraction between that of the core and that of the cladding; less than that of the cladding or greater than the index of refraction of the core. For example, the filler material may be a transparent epoxy.

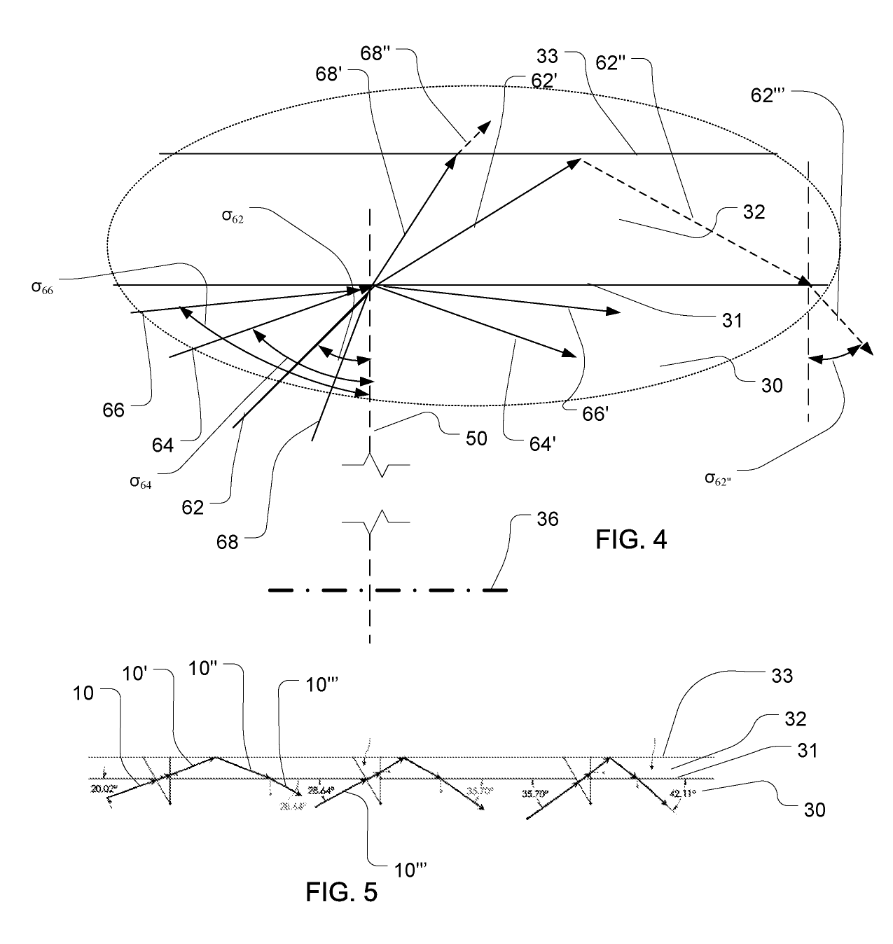

In operation, light from a source 60 such as a lamp, light emitting diode or laser is directed into the upstream end 39 of the fiber. The light includes light propagating within the core 30 at various angles to the axis 36 of the fiber. As best seen in FIG. 4, light such as ray 62, propagating at a large angle to the axis 36 of the fiber, strikes the interface 31 between the core 30 and cladding 32 at a relatively small angle σ₆₂ to the radial line 50 which is normal to the interface 31, and is refracted along a ray path 62′. The angle relative to the normal at which the light strikes an interface is referred to as the “angle of incidence”. Light such as ray 64, propagating at a smaller angle to axis 36, strikes interface 31 at a larger angle of incidence σ₆₄ and is reflected back into the core at the same angle σ₆₄ to the normal, as indicated by path 64′. Ray 66, passing almost parallel to axis 36, strikes the interface at an even larger angle of incidence σ₆₆, and is reflected back into core 30 at the same large angle σ66. The minimum angle of incidence at which the light will be reflected at the interface between the core and the cladding is referred to herein as the “critical angle” for that interface. The critical angle depends on the indices of refraction of the core and cladding; it is given by the equation

σ_{critical}=arcsin(η_{cladding}/η_{core})

where σ_{cladding} is the index of refraction of the cladding 32 and η_{core} the index of refraction of core 30. For any angle of incidence greater than σ_{critical}, the light will be reflected at interface 31. For any angle of incidence less than σ_{critical}, the light will pass into the cladding 32. For the particular fiber shown in FIGS. 1-4 , σ_{critical} is 69.98 degrees.

Typically, within the transmission region 38, cladding 32 of the fiber is surrounded by a coupling medium having an index of refraction close to that of the cladding, or by a light-absorbing medium such as an opaque jacket (not shown). In this case, the light passing into the cladding along will pass out of the fiber or will be absorbed. Therefore, essentially all of the light passing downstream along the fiber will be transmitted within the core. The light transmitted in this manner will consist of rays travelling within the core along paths within a range of angles less an angle referred to herein as the “maximum propagation angle” from parallel to axis 36 of the fiber and thus striking the core/cladding interface at angles of incidence greater than the critical angle. The maximum propagation angle is the complement of the critical angle, i.e., (90−σ_{critical}) degrees. In the particular fiber shown, the maximum propagation angle is 20.02 degrees. This light is reflected repeatedly, so that the light travels along zizgzag paths as represented schematically by rays 64 and 66 in FIG. 1. Because the light can travel along various zigzag paths, transmission of light in this manner is referred to as “multimodal” transmission, and an optical fiber which can transmit light in this manner is referred to as a “multimode” fiber.

If the cladding is surrounded by air, which has an index of refraction of approximately 1.0, or by another medium having an index of refraction lower than the index of refraction of the cladding, some of the light passing into the cladding will be reflected at the outer surface of the cladding, by total internal reflection at the interface between the cladding and the surrounding medium. In the particular fiber shown, the critical angle for the cladding-to-air interface is approximately 46 degrees. Light striking the cladding-to-air interface at the outer surface 33 of the cladding at an angle greater than this critical angle will be reflected. Total internal reflection of light passing along ray 62′ at the outside of the cladding is depicted by in indicated by ray 62″ in FIG. 4. This light is refracted again at the interface 31, so that the light will pass back into the fiber along path 62′″, at the same angle to the normal σ₆₂ as the original ray 62. This light will continue to travel along a zigazag path (not shown) including the core and cladding. In practice, some of this light may pass out of the cladding, particularly if the surface 33 of the cladding is rough. Light passing through the core at an even steeper angle to the axis, and an even smaller angle to the normal, such as along ray 68, will be refracted into the cladding 32 along ray 68′. Ray 68′ has an angle of incidence with the cladding-to-air interface 33 less than the critical angle of this interface. Thus, ray 68 will not be reflected at the interface 33, so that this light will escape from the fiber.

Within emission region 40 (FIG. 1), light propagates through the core of the fiber in the same manner discussed above, with light passing along a range of zigzag paths. Those rays which happen to strike the interface 31 between the core and cladding at locations between turns of the indentation 42 are reflected at the interface 31 between the core and cladding in the same manner discussed above with respect to the transmission section 40. However, the interruption will alter the paths of those rays which encounter it, and some of these rays will be diverted outwardly into the cladding 32.

As best seen in FIG. 3, light ray 20 at the maximum propagation angle of 20.02 degrees to the axis 36 of the fiber and thus is directed at the critical angle σ_{critical} to the normal defined by the uninterrupted portions of the core-to-cladding interface 31 , i.e., at angle of 69.98 degrees to normal line 50. As discussed above, this ray would be reflected back into the core at the core to cladding interface 31. However, ray 10 encounters the upstream surface 44 of the indentation. Because upstream surface 44 is oblique to the axis, the normal line 70 to surface 44 is also oblique. The angle of incidence σ₁₀₋₄₄ of ray 10 is lower than the angle of incidence which the same ray would have at interface 31. In this example, σ₁₀₋₄₄ is 9.98 degrees. Moreover, the index of refraction of the filler material 52 within the indentation is greater than the index of refraction of the cladding, so that the critical angle for total internal reflection is larger than the critical angle at interface 31. Ray 10 is not reflected, but instead passes through the surface 44 of the indentation. It is refracted slightly away from normal line 70, (to an angle of 10.12 degrees to normal line 70) and propagates through the filler material 52 in the indentation to the downstream surface 46 of the indentation. At the downstream surface, the ray encounters an interface between the filler material 52 and the cladding and passes into the cladding. Because the downstream surface 46 of the indentation is perpendicular to the axis 36 of the fiber, the normal line 14 perpendicular to this surface is parallel to the axis 36 of the fiber. Because the cladding has an index of refraction lower than the index of refraction of the filler material, ray 10 is refracted slightly away from the normal. The angle of incidence at downstream surface 46 is about 19.88 degrees, whereas the ray 10′ passing into cladding 32 is directed at an angle of about 20.92 degrees to the normal line 14, i.e., at an angle of about 20.92 degrees to the axis 36 of the fiber, and will encounter the cladding-to-air interface, at the outer surface 33 of the fiber at an angle of incidence σ_{10′-33} of about 69.08 degrees.

Light travelling along other paths (not shown) more nearly parallel to the axis 36 than ray 10, also will be directed outwardly, into cladding 32, but at shallower angles to the axis than ray 10′. However, some light which is directed along paths very nearly parallel to axis 36, as shown by ray 11 in FIG. 3, will be refracted back into the core 30 as it passes through the interfaces between the filler material and the core. Also, some light which encounters the upstream surface of the indentation at too large a depth will not reach the cladding. Ray 13, depicted in FIG. 3, is parallel to ray 10 but at a depth such that the refracted ray passing through the filler material will just hit the core to cladding interface 31. The region 14 of the upstream surface 44 between the core to cladding interface 31 and ray 13 thus defines a target region of the upstream surface. Light directed parallel to ray 10, or at shallower angles to the axis, will be directed into the cladding only if it strikes the target region 14 of the upstream surface.

If the emission region 40 is surrounded by an optical coupling material having an index of refraction close to or greater than the index of refraction of cladding 32, substantially all of the light diverted into the cladding will pass out of the cladding into the surrounding medium.

However, if the emission region 40 is surrounded by air or by another medium having an index of refraction substantially less than that of the cladding 32, the light directed into the cladding along ray 10′ will be reflected back into the cladding by total internal reflection at the outer surface of the cladding. For example, where the emission region is surrounded by air, the critical angle at the cladding-to-air interface is approximately 45.48 degrees. The angle of incidence σ_{10′-33} of ray 10′ is greater than this value, and hence total internal reflection will occur at the interface between the cladding and the air. However, the reflected ray 10″ will pass back to the core-to-cladding interface, and will be refracted to an angle of about 28.64 degrees to the axis 36 within the core as shown at 10′″ in FIG. 5. Stated another way, the successive refractions and reflection encountered by this ray will direct the ray back into the core at a steeper angle to axis 36. This ray will be at an angle of incidence less than the critical angle at the core-to-cladding interface. If it encounters regions of the interface between turns of the indentation 42, it will propagate downstream through the fiber by successive reflections at the cladding to air interface, in the same manner as ray 62, discussed above with reference to transmission section 40 and FIG. 4. However, it will eventually encounter another turn of indentation 42, and will be again refracted and reflected so as to direct it at an even steeper angle to the axis. This process continues until the ray eventually reaches an angle of incidence less than the critical angle at the cladding-to-air interface 33. Thus successive steepening is schematically shown in FIG. 5. After passage through one turn of the indentation, ray 10 has steepened to 28.64 degrees at 10′″. The same ray, after passing through a second turn of the indentation, is directed at 35.70 degrees to the axis. After passing through a third turn, the ray reaches an angle of 42.11 degrees to the axis. The same process of successive steepening will affect rays which are initially directed at smaller angles to the axis; all will eventually travel through the cladding 32 at angles steep enough to pass through the cladding-to-air interface and exit from the fiber, but may require passage through more turns of the indentation.

The fiber as discussed above can provide illumination effective illumination along the length of the emission region 40. Moreover, the fiber can be fabricated readily from commercially-available polymeric multimode optical fiber by forming the indentation 42 in the desired emission region 40, while leaving the desired transmission region 40 devoid of indentations. One of the most consistent and controllable methods to make a helical indentation 42 is to rotate the fiber against a cutting tool, such as a carbide, steel or diamond edge while moving the cutting tool or fiber in a direction parallel to the axis of the fiber. A machine tool such as a lathe that rotates both ends of the material to be worked (the fiber) may be used, as polymeric optical fiber cannot transfer torque applied at one end along the length of the fiber. For example, glassblowing lathes are designed for this type of application given the inability of the originally designed for working medium, molten glass, to support torque.

In the embodiment discussed above, the helical indentation has a uniform pitch, i.e., a uniform distance between turns of the indentation. Each turn of the indentation typically extracts a percentage of the light propagating in the core of the fiber per each circumferential cut. Because light is extracted from the fiber as the light propagates in the downstream or distal direction within the emission region 40, the optical power of the light propagating in the emission region diminishes progressively in the distal direction. Thus each sequentially distal turn of the indentation will extract less light, as there are simply fewer photons available for extraction at each more distal location. To achieve a uniform output of extracted light per unit length along the length of the emission region, the pitch of the indentation (rotations per unit length) may be adjusted along the length such that the pitch density increases in the distal direction. This increase can be linear, or the rate of increase can be varied along the length of the emission region. Indeed, the pitch can be varied as desired to achieve any desired pattern of light output along the length of the emission region.

Also, plural indentations can be provided, rather than a single helical indentation as discussed above. Two or more helical indentations can be formed as, for example, with turns of one indentation disposed between turns of another indentation. Also, the indentations can be provided as discrete indentations spaced apart from one another along the length of the emission region. For example, indentations may be formed as discrete cuts oriented transverse to the axis of the fiber. These discrete cuts may be distributed at uniform or non-uniform distances from one another in the axial or upstream-to-downstream directions. Also, discrete cuts may be formed in equal numbers around the circumference of the fiber to provide substantially equal emission in all directions transverse to the axis of the fiber, or may be provided only at certain locations around the circumference of the fiber to provide unequal emission.

For an indentation or indentations of a given shape, the size of the target area on the upstream surface of the indentation, and thus the percentage of the light extracted can be adjusted by changing the depth of indentation; the deeper the cut, the larger the target area. In another variant, the depth of the indentation or indentations can vary along the length of the emission region. In one example, to maintain a uniform emission along the length of the emission region, the depth of the indentation or indentations can increase progressively in the downstream direction.

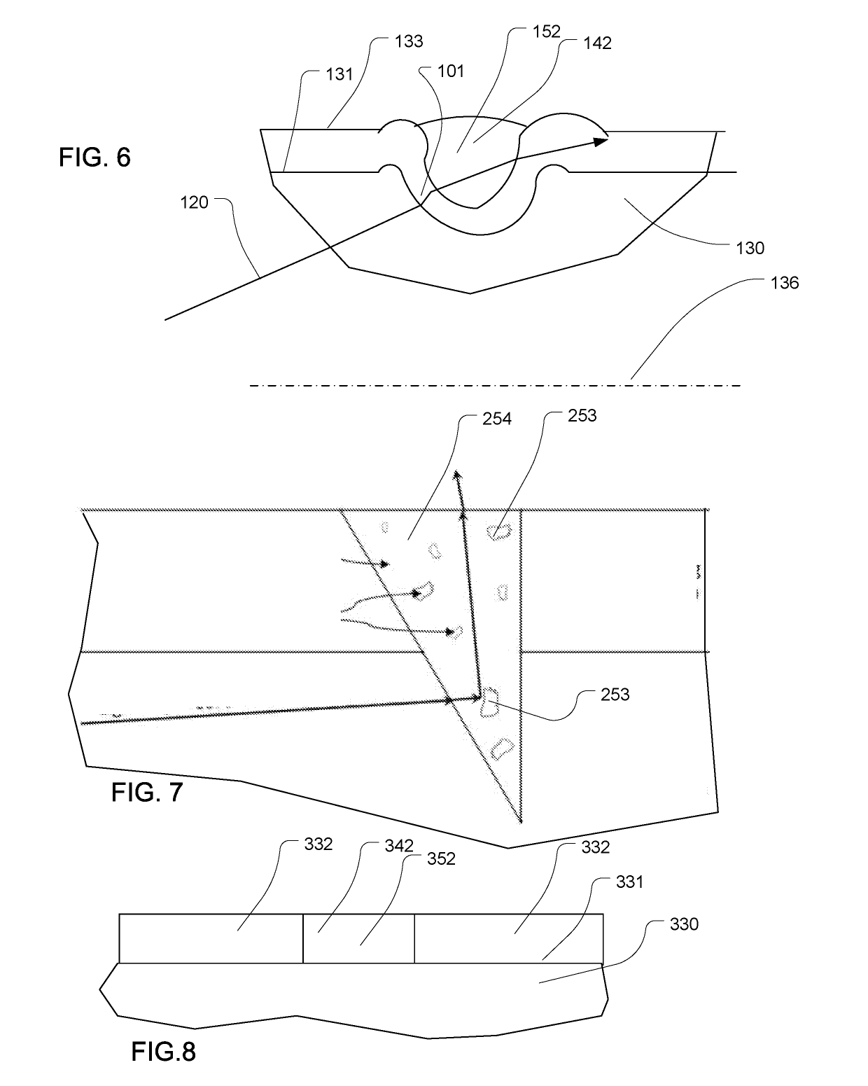

The shape of the indentations can be varied. For example, the orientations of the upstream and downstream surface relative to the axis may be varied from those shown above. In other variants, these surfaces may be curved as seen in a sectional view on a diametric plane, rather than straight as depicted in FIG. 3. It is not essential for the filler material to directly contact the material of the core in the indentations. Moreover, the indentations may be formed by processes other than use of a cutting tool. As depicted schematically in FIG. 6, a fiber according to a further embodiment has an indentation 142 formed by forcing a blunt tool into the fiber as, for example, forcing a roller into the outer surface 133 of the cladding to displace, rather than remove, the material of the cladding and some material of the core. Here again, the indentation extends into the core 130 of the fiber, i.e., extends toward the axis 136 of the core, to a radius from axis 136 less than the radius of core-to-cladding interface 131 in undisturbed areas of the fiber. Such a process may leave a layer of cladding material 101 lining the upstream and downstream surfaces of the indentation, even in regions of the indentation disposed inside the core. Here again, however, the upstream surface of the indentation is oblique to the axis, so that light such as ray 120 at the maximum propagation angle of the fiber will be refracted rather than reflected, and will pass out of the core. Because the layer 101 of cladding material is interposed between the material of core 130 and the filler material 152 disposed in the indentations, the exact pattern of refraction will be more complex than that discussed above, but the same general result will occur.

In the embodiments discussed above, the filler material in the indentations is transparent. However, the filler material may be a light-scattering material. For example, the filler material may include particulates, voids or other discrete light-reflecting elements dispersed in a transparent matrix. With reflective elements in the filler material, light rays can be directly reflected out of the filler into the surrounding medium.

For example, the embodiment shown in FIG. 7 is generally similar to the embodiment discussed above with reference to FIGS. 1-4, but has a filler material 252 with BaSO₄ particles 253 dispersed in a transparent matrix 254 such as an epoxy or silicone. Light passing into the indentation is reflected by the particles and thus scattered, so that some of the light will pass out of the fiber at the indentation. The scattering cross section and preferred scattering direction may be calculable for some particulates, but for simplification, it is typically assumed that low particulate concentrations are used to keep the overall scattering cross section smaller and that that the scattering directions are random. Many of these randomly scattered rays will exceed the steepness required to pass through the other high to low index of refraction interfaces of the system and enter the surrounding medium. These particulates can be the aforementioned barium sulfate, typically chosen for its broad-spectrum reflectivity, or some another material, with the particulate size and spectral reflectivity chosen appropriate to the particular application.

The concentration of these particulates in the kerf filler matrix may be adjusted to achieve the desired amount of light extraction at each indentation in the fiber. Alternatively, the particle size , the material constituting the particles, or both, can be varied along the length of the emission region to change the properties of the light most efficiently extracted from the core of the fiber. In the case where the fiber carries multiple colors, or frequencies of light, this technique can be used to extract these different colors at different point along the fiber. Or, this technique can be used as a filter, to preferentially pull out unwanted frequencies from the core of the fiber.

In the embodiments discussed above, the extension of the indentations into the core of the fiber provides enhanced light extraction from the core. However, some light extraction from the core into the cladding can occur even where the indentation extends to the core but not into the core. For example, in the embodiment of FIG. 8, an indentation 342 extends to the surface of core 330, but not into the core. The indentation is filled with a filler material 352 having an index of refraction higher than the index of refraction of the cladding 332. Therefore, the critical angle at the interface between the filler material and the core will be smaller than the critical angle at the core-to-cladding interface 331. Some light propagating at and near the maximum propagation angle defined by the core-to-cladding interface will be refracted into the filler material 352 and will pass into the cladding. In a further variant, a filler material with an index of refraction higher than the index of refraction of the core can be used, eliminating the conditions for total internal reflection.

Conversely, in those embodiments which include indentations extending into the core, the filler material may be omitted. In this case, the indentations will be filled with air or any other medium which surrounds the emission region of the fiber. The indentations will still permit extraction of at least some light from the core of the fiber.

In the foregoing discussion, it has been assumed that the axis of the fiber is a straight line. However, because the fiber is a polymeric fiber of relatively small diameter, it can be bent into a curved shape, such that the axis 36 of the fiber is curved. However, the fiber will work in substantially the same manner as discussed above, so as to emit light from emission section 40 into the surrounding medium. Although forming the fiber into a curved configuration will vary the exact angles of incidence of the light rays, the mode of operation will remain essentially the same as discussed above. In general, light emission from the emission region will increase when the fiber is in a curved configuration. Stated another way, in a fiber of infinite length, in a straight line, all but the propagating modes (with angles to the fiber axis less than the maximum propagation angle) will dissipate over some length. In practice of course fibers are not infinite, or straight. Bends can force certain propagating modes into incidence angles that lead the light out of the core and potentially out of the fiber. Where the emission region of the fiber is bent, this action supplements the action of the features discussed above. The ability to bend the fiber into a curved shape is highly advantageous in some applications. In this regard, the solid filler material in the indentations enhances the structural integrity of the fiber. The preferred polymeric optical fibers can be formed into curved configurations such as loops by annealing the fiber in the curved configuration at an elevated temperature as, for example, about 80 degrees C. Where the filler is a thermoset epoxy, the annealing process desirably is carried out either before application of the filler material or after curing of the filler material, so as to avoid a rapid exothermic curing of the epoxy which may overheat adjacent areas of the fiber.

In the embodiment discussed above with reference to FIGS. 1-4, the fiber includes a transmission region 40. However, the transmission region may be omitted, i.e., the emission region may extend over the entire length of the fiber. In a further variant, a plurality of separate emission regions can be formed at locations along the fiber, with transmission regions extending between the emission regions.

An optical device in accordance with a further aspect of the invention may include a fiber as discussed above, and may also include an optical coupling material surrounding the emission region of the fiber. The optical coupling material may have an index of refraction higher than that of air, and desirably approximately equal to or greater than the index of refraction of the cladding, to facilitate transmission of light out of the cladding.

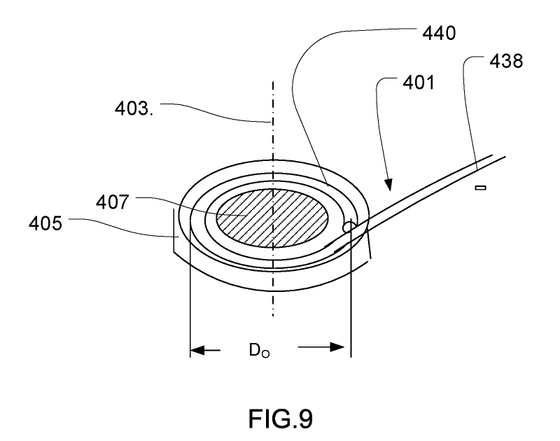

One particularly useful application of the fibers and optical devices discussed herein is in application of ultraviolet or blue light for the purpose of corneal crosslinking as disclosed in US Published Patent Application US2014/0379054 (the “'054 Publication”), the disclosure of which is hereby incorporated by reference herein. An optical device suitable for such use is shown in FIG. 9. This device includes a fiber 401 such as a fiber discussed above having a transmission region 438 and an emission region 440. The emission region is formed in at least one loop at least partially encircling a loop axis 403. The loop desirably has an outer diameter of about 25 mm or less, more desirably about 12 mm or less. Stated another way, the emission region is bent to a radius of curvature of about 12 mm or less, more desirably about 6 mm or less. To provide substantially uniform emission around the circumference of the loop, the pitch of the indentations desirably varies along the axial extent of the emission region 440, so that the distance between indentations decreases in the downstream direction around the loop. Also, although only one loop is shown in FIG. 9, the emission region may be formed into two or more loops. The emission region is embedded in a mass 405 of optical coupling material which may be in a generally disc-like or dome-like configuration. The mass may include an optically scattering portion 407 adjacent the loop axis. As discussed in the '054 Publication, light emitted from the fiber will pass into the mass 405, towards the axis 403, and will be scattered so in scattering portion 407 so that the light passes downwardly as seen in FIG. 8, in a direction generally parallel to the loop axis. A circumferential reflector (not shown) may encircle the peripheral surface of the mass and thus encircle the fiber loop, to assure that the light initially emitted in the looped emission region 440 will pass inwardly toward the axis. A further reflector (not shown) may be provided over the top surface of the mass, to redirect any light scattered upwardly by the scattering region 407 of the mass.

An optical device as shown in FIG. 8 may be mounted in a housing (not shown) having a size and shape corresponding to a contact lens, so that the housing and device can be placed over an eye of a subject. The fiber and optical device are small enough in size to accommodate such mounting, but nonetheless can provide a pattern of illumination directed downwardly into the eye of the subject which is highly uniform. In particular, the pattern of illumination can have excellent uniformity in a circumferential direction around the loop axis. Moreover, the optical device and fiber can be made economically.

As used in the present disclosure, the term “light” should be understood as including ultraviolet and infrared radiation, as well as light within the visible portion of the spectrum.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. An optical fiber having an elongated transparent core having an axis of elongation, a cladding surrounding the core, the cladding having an index of refraction lower than an index of refraction of the core, and one or more indentations extending from outside of the cladding into the core so that the indentations define one or more surfaces sloping towards and away from the axis of elongation and extending into the core.

2. An optical fiber as claimed in claim 1 further comprising an optically transmissive solid filler disposed in the indentations in contact with the core.

3. An optical fiber having an elongated transparent core having an axis of elongation, a cladding surrounding the core, the cladding having an index of refraction lower than an index of refraction of the core, one or more indentations extending from outside of the cladding at least to the core, and an optically transmissive solid filler disposed in the indentations.

4. An optical fiber as claimed in claim 2 or claim 3 wherein the filler has an index of refraction less than or equal to the index of refraction of the core.

5. An optical fiber as claimed in any of claims 1-3 wherein the filler is transparent.

6. An optical fiber as claimed in any of claims 1-3 wherein the filler is optically scattering.

7. An optical fiber as claimed in any of claims 1-3 wherein the one or more indentations include at least one helical indentation extending around the axis of elongation.

8. An optical fiber as claimed in any of claims 1-3 wherein the core and cladding are polymeric.

9. An optical fiber as claimed in claim 8 wherein the core has a diameter of 50 μm or more.

10. An optical fiber as claimed in claim 9 wherein the cladding has an outer diameter less than 1.2 times the diameter of the core.

11. An optical device including an optical fiber as claimed claim 8 wherein the fiber includes a curved portion and at least some of the one or more indentations are disposed in the curved portion.

12. An optical device as claimed in claim 11 wherein the curved portion includes at least one loop extending around a central axis, the loop having a loop diameter of 25 mm or less .

13. An optical device as claimed in claim 12 further comprising a solid, optically transmissive medium surrounding the cladding and extending from the loop toward the central axis.

14. An optical device as claimed in claim 13 further comprising a reflector having a circumferential surface extending outside of the loop and at least partially surrounding the central axis

15. An optical device comprising an optical fiber as claimed in any of claims 1-3 and a solid, optically-transmissive medium in contact with the cladding adjacent the indentations.

16. An optical device as claimed in claim 15 wherein the medium has an index of refraction greater than or equal to the index of refraction of the cladding.
